(19) United States
(12) Patent Application Publication
(10) Pub. No.: US 2020/0033093 A1
(43) Pub. Date: Jan. 30, 2020

(54) Sliding Battery and Light Carriage for Archery Sight Bar

(71) Applicant: Jamie A. Kruger, Madison, WI (US)

(72) Inventor: Jamie A. Kruger, Madison, WI (US)

(21) Appl. No.: 16/590,169

(22) Filed: Oct. 1, 2019

Related U.S. Application Data
(60) Provisional application No. 62/802,566, filed on Feb. 7, 2019.

(51) Int. Cl. F41G 1/467; F21V 21/088; F21V 21/08

(52) U.S. Cl. CPC F41G 1/467; F21V 21/0808; F21V 21/088

(57) ABSTRACT

A mount assembly for attachment to a sight bar of a bow includes a slidable carriage, a locking mechanism, and an attachment member. The slidable carriage has a flat upper surface and a channel passing through a body of the mount parallel to the upper surface. The channel is preferably configured to slidably permit insertion of an archery sight bar. The locking mechanism is positioned on the body of the carriage to engage the sight bar and prevent movement of the carriage, while the attachment member is positioned on the upper surface and is configured to secure an archery-light or power source to the carriage.

### RELATED APPLICATION

This application claims the filing priority of U.S. Provisional Application No. 62/802,566 titled “Sliding Battery And Light Mount For Archery Sight Bar” filed on Feb. 7, 2019. The '566 application is hereby incorporated by reference.

### TECHNICAL FIELD OF THE INVENTION

The present invention relates to sight bar carriages for power device. More specifically, the invention relates to a slidable carriage used on an archery sight bar for attaching a light source.

### BACKGROUND OF THE INVENTION

Archery is a precision sport where the difference between first place and second place can be measured in centimeters. For this reason, those in the sport, young and old, spend countless hours practicing and perfecting techniques. Often, they do so with elite, precise equipment, from bows to sights, which help a shooter align and remain balanced with each shot. That is, except for sight lights.

A sight light is used to provide illumination to the shooter. The sight lights themselves are often state-of-the-art, with digital technology, LED lights, variable intensity, and programmable features. However, as shown in FIGS. 1-4, these devices are being attached to a sight bar by an antiquated method using Velcro® straps. It is common for the light device to be removed fairly often to allow either replacement or recharging of batteries. And while Velcro® itself is simple to use, securely attaching and reattaching sight lights can be difficult and frustrating for the most experienced of archers. It can be particularly troublesome for younger participants of the sport.

With the low-tech attachment system, the sight light is typically loosely attached or becomes loose in a short time and wobbles and/or slides on the sight bar. This can throw off a shooters balance or just become a nuisance during competition and practice. Accordingly, an improved means and/or method for attaching a light to a sight bar is greatly needed.

Until the invention of the present application, these and other problems in the prior art went either unnoticed or unsolved by those skilled in the art. The present invention provides a secure carriage which performs multiple functions with the associated lighting device without sacrificing simplicity, portability, design, style or affordability.

### SUMMARY OF THE INVENTION

There is disclosed herein an improved light mount assembly and carriage for use with an archery sight bar which avoid the disadvantages of prior devices while affording additional structural and operating advantages.

Generally speaking, the light mount assembly comprises a carriage having a slidable base, a locking mechanism, and an attachment member. The slidable base has a flat upper surface and a channel passing through a body of the base parallel to the upper surface. The channel is preferably configured to permit slidable insertion of an archery sight bar. The locking mechanism is adjustable and is positioned on the body of the base to engage the sight bar and prevent movement of the base, while the attachment member is positioned on the upper surface and is configured to secure an archery-light to the base.

In specific embodiments, the channel of the carriage comprises a dovetail (or trapezoidal) cross-section open at the base, as the most popular sight bars have a similar dovetail (or trapezoidal) shape. Other symmetrical and asymmetrical channel shapes may also be used for sight bars having different cross-sectional shapes.

Further, the locking mechanism preferably comprises a set screw passing through an opening in a side of the base. The set screw can be turned to contact the sight bar when the base is attached and prevent slidable movement. A nylon tip on the set screw allows a proper amount of frictional force to retain the base without scratching or otherwise marring the surface of the sight bar. The attachment member is preferably comprised of a double-sided tape.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIGS. 1-4 are various views illustrating a prior art carriage for connecting a light source to a sight bar using a Velcro® strap;

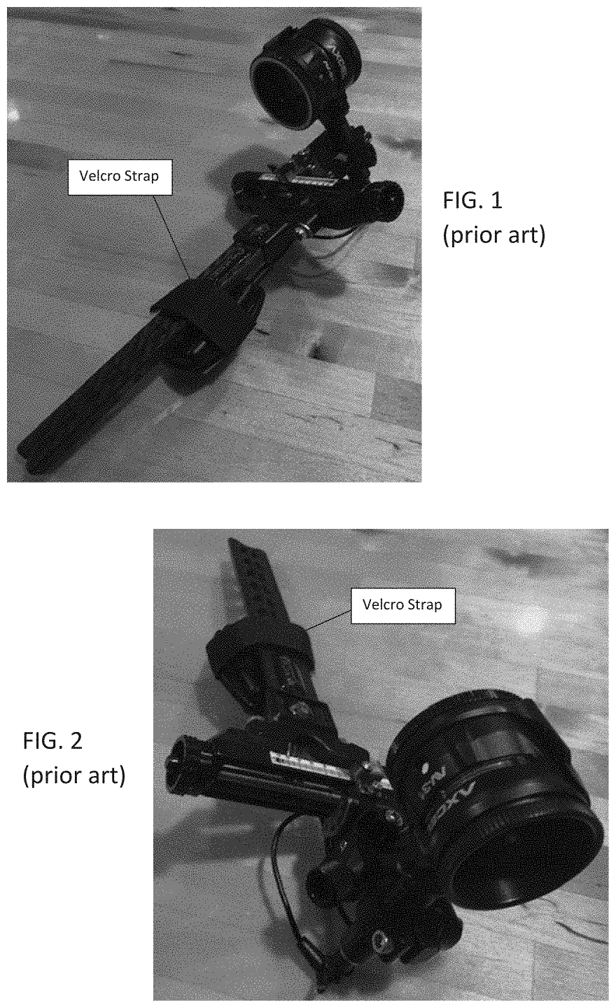

FIG. 5 is a bottom perspective view of an embodiment of the disclosed carriage attached to a sight bar and holding a battery pack for a light source;

FIG. 6 is a bottom view of the carriage of FIG. 5;

FIG. 7 is a side view of the carriage of FIG. 5; and

FIG. 8 is a side perspective view of the carriage of FIG. 5;

FIGS. 9A-9E are a series of views, including a perspective, side, top, end and partial, respectively, showing an embodiment of the disclosed carriage;

FIGS. 10A-10D are a series of views, including a perspective, side, top and end, respectively, showing an embodiment of the disclosed carriage;

FIGS. 11A-11D are a series of views, including a perspective, side, top and end, respectively, showing an embodiment of the disclosed carriage;

FIGS. 12A-12D are a series of views, including a perspective, side, top and end, respectively, showing an embodiment of the disclosed carriage;

FIGS. 13A-13D are a series of views, including a perspective, side, top and end, respectively, showing an embodiment of the disclosed carriage;

FIGS. 14A-14D are a series of views, including a perspective, side, top and end, respectively, showing an embodiment of the disclosed carriage;

FIGS. 15A-15D are a series of views, including a perspective, side, top and end, respectively, showing an embodiment of the disclosed carriage;

FIGS. 16A-16D are a series of views, including a perspective, side, top and end, respectively, showing an embodiment of the disclosed carriage; and

FIGS. 17A-17D are a series of views, including a perspective, side, top and end, respectively, showing an embodiment of the disclosed carriage.

### DETAILED DESCRIPTION OF THE INVENTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

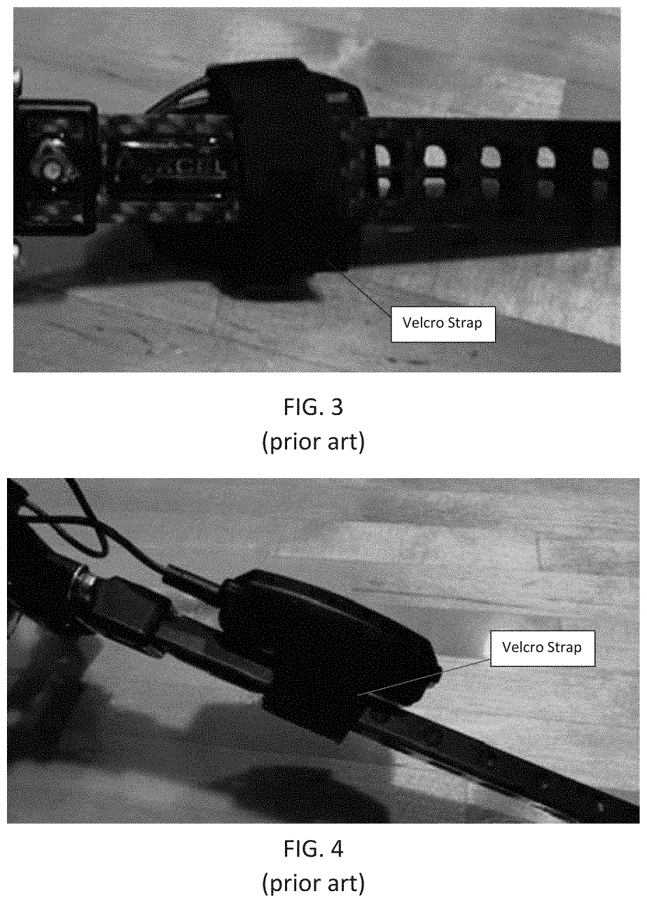

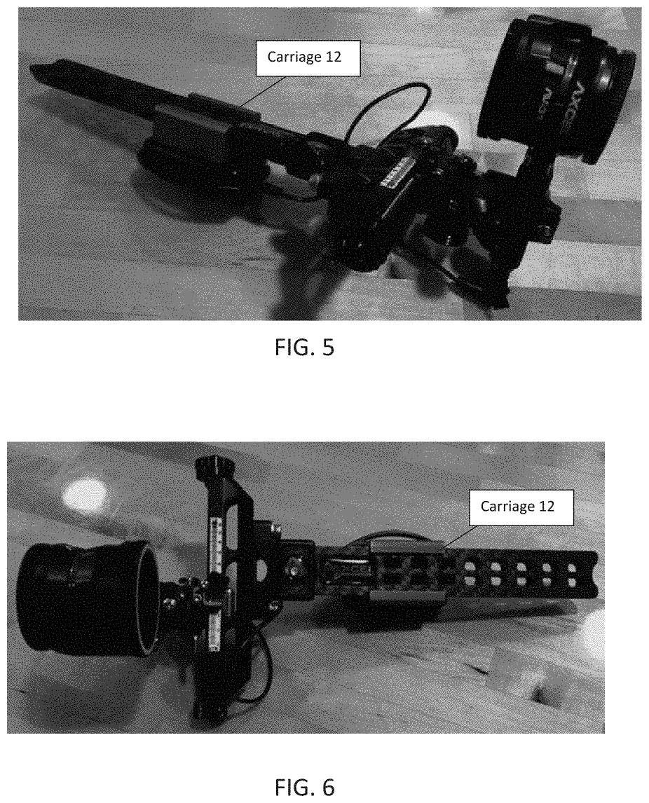

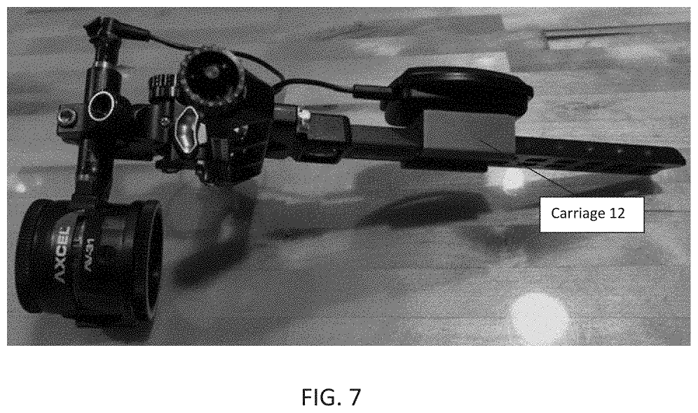

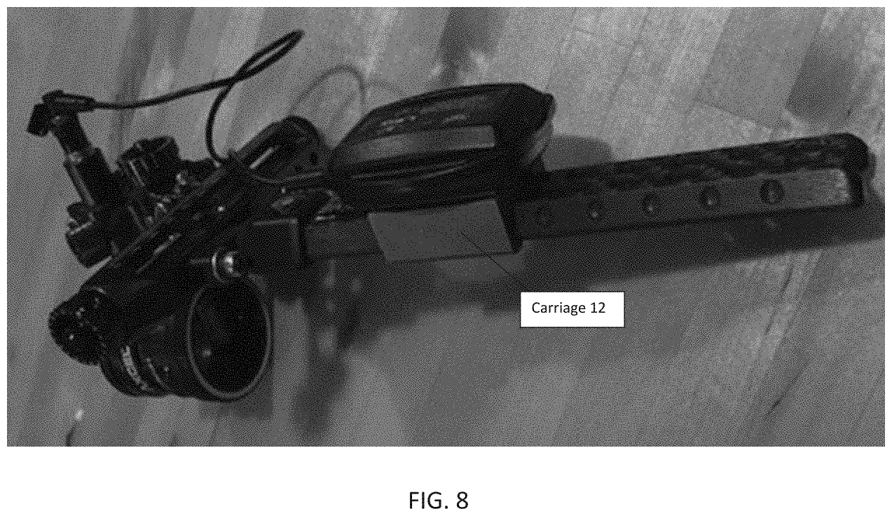

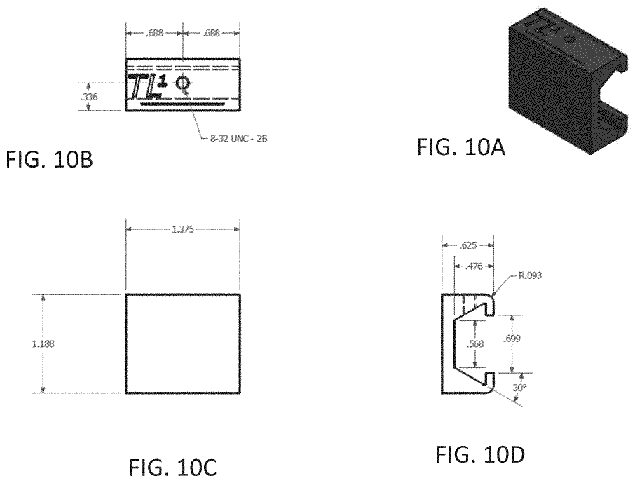

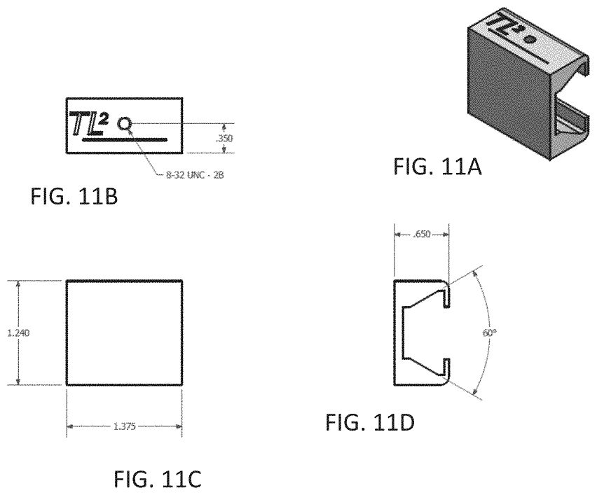

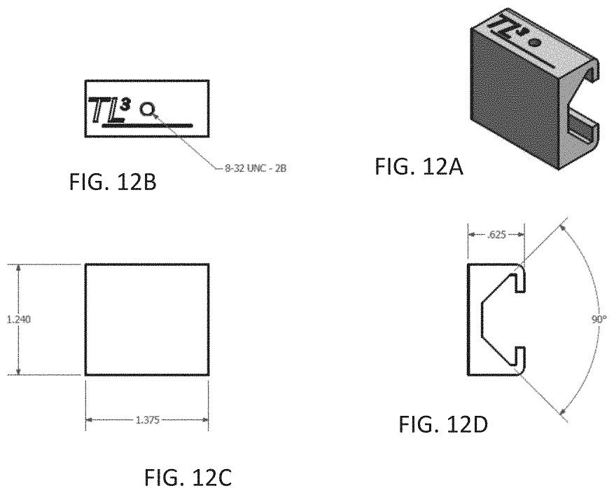

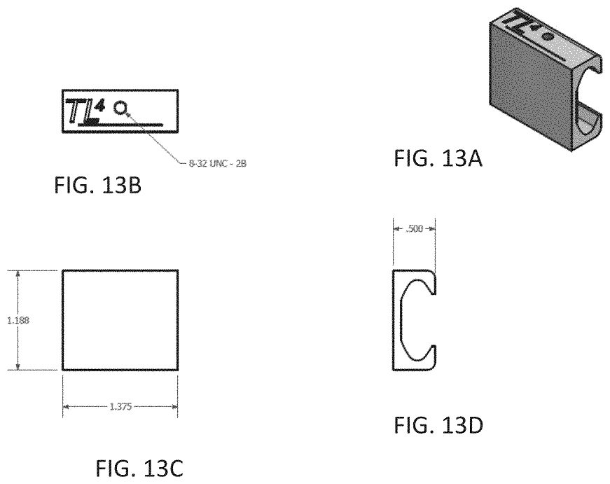

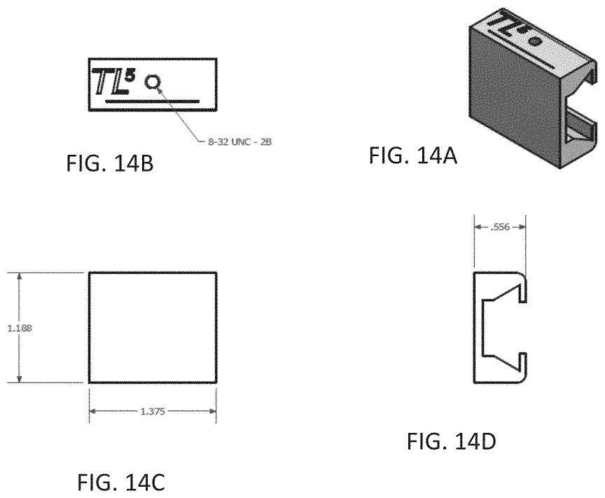

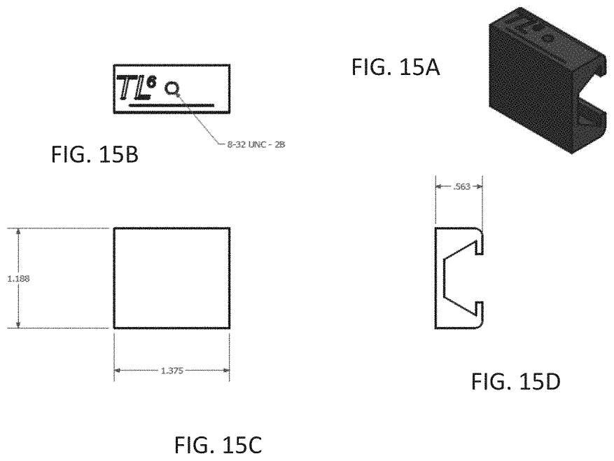

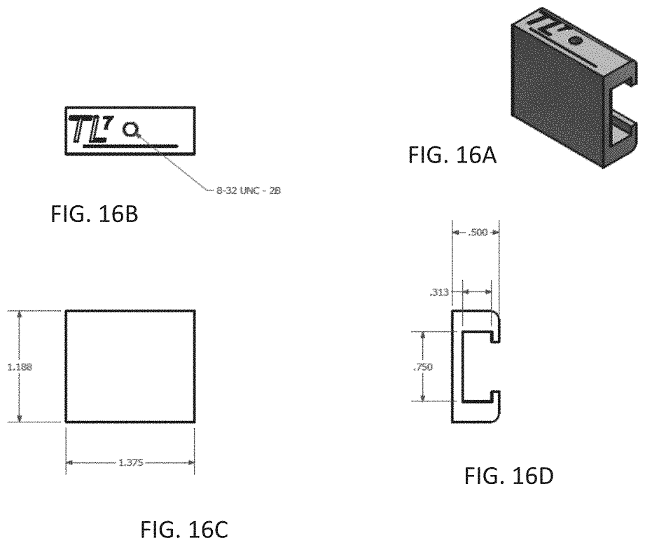

Referring to FIGS. 5-17, there is illustrated at least one preferred embodiment of an archery light mount assembly, generally designated by the numeral 10. The particular illustrated mount assembly 10 is for attachment to a sight bar 40 for an archery bow (not shown). However, while the preferred embodiment illustrated and described below is directed to a carriage 12 for a dovetailed (or trapezoidal) sight bar 40, it should be understood that the principles of the invention can be more broadly applied to any shape of sight bar used in the sport of archery, as well as other types of target or shooting sports.

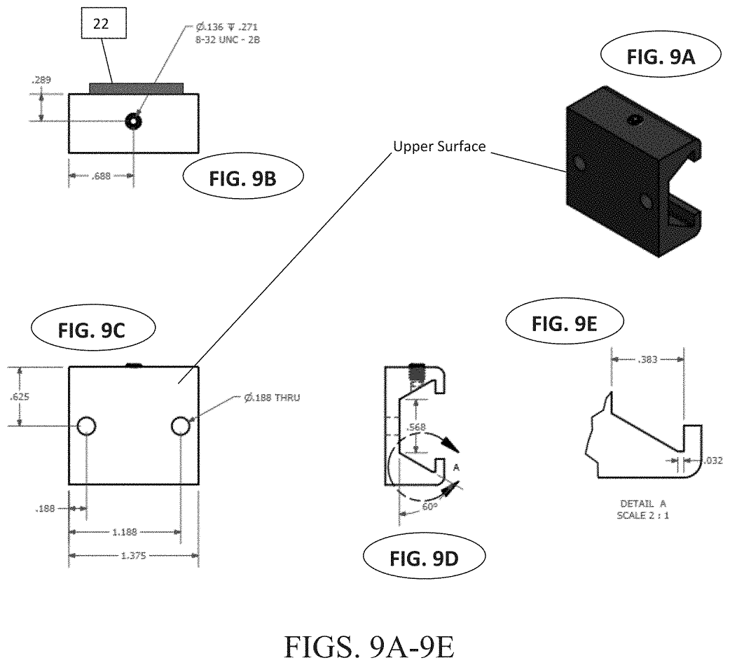

As can be seen in FIGS. 5-8, the carriage 12 of the assembly 10 is comprised of a body 14, preferably made from a machined aluminum block, with a flat upper surface 16 and a dovetail or trapezoid-shaped channel 18 through the body 14 and parallel to the upper surface 16. Two mounting holes 20 may be drilled into the upper surface 16 for accepting mounting screws of specific light systems—e.g., Zbros, Specialty Archery, LP Light, Schlite Light, as well as any others—if available. Otherwise, adhesive tape 22 (see FIG. 9B), such as a double-sided foam tape made by the 3M Company, may be used as an attachment member by adhering one side of the tape 22 to the flat upper surface 16. The opposite side of the tape 22 can be reserved for attaching a device 42, such as an archery light, a battery pack, or some other useful component for the archery light mount assembly 10.

A locking mechanism 24 is used to lock the carriage 12 to the sight bar 40. In the disclosed embodiments, a set screw 26, preferably hex head with a nylon tip, is set into a threaded hole 28 passing through the side arm of the carriage 12. The screw 26 may be used to engage the sight bar 40 after attachment of the carriage 12 to prevent movement, Loosening of the screw 26 allows adjustment or removal of the carriage from the bar 40. Other types of screws and pins may be used for specific embodiments, if desired.

The purpose of this mounting assembly 10 is to securely hold a light (or other device) on an archery sight bar 40. Advantages include a reduction in vibration, a reduction in movement during shooting, and ease of installation for young and experienced archers.

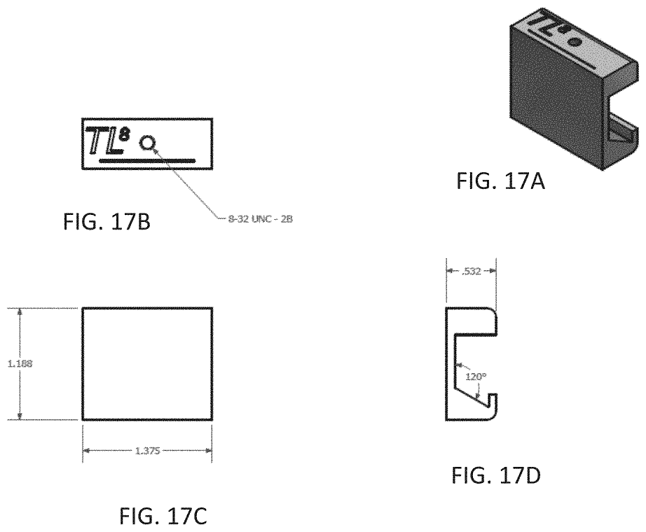

Referring to FIGS. 9-17, alternate embodiments of the carriage 12 are shown. The carriage 12 is preferably substantially C-shaped, as shown in most of the figures, when viewed from the end (see view D of FIG. 9-17). The channel 18 is preferably symmetrical along both the lateral and longitudinal planes, but as shown in FIGS. 17A,D it may be asymmetrical along the longitudinal plane. The internal surfaces 30 of the channel 18 are intended to correspond to surfaces of a sight bar—i.e., similar geometric shapes—to allow easy sliding along the sight bar. However, some channels 18 may be contoured to couple with several different shaped sight bars. This is useful only when the locking mechanism 24 is able to contact the bar 40 to prevent sliding.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. An archery light mount assembly comprising:
an archery sight bar configured for attachment to an archery bow, the sight bar having a geometric shaped cross-section;
a slidable carriage having a flat upper surface and a channel passing through a body of the carriage parallel to the upper surface, the channel configured for slidable insertion of the archery sight bar;
an adjustable locking mechanism passing through the body of the carriage to both engage the sight bar and prevent movement of the carriage relative to the sight bar and to disengage the sight bar to allow movement of the carriage relative to the sight bar; and
an attachment member positioned on the upper surface and configured to secure an archery light or power source to the carriage.

2. The archery light mount assembly of claim 1, wherein the channel comprises a dovetail cross-section.

3. The archery light mount assembly of claim 1, wherein the channel comprises at least five flat surfaces.

4. The archery light mount assembly of claim 1, wherein a shape of the channel in cross-section is substantially identical to the geometric shape of the sight bar in cross-section.

5. The archery light mount assembly of claim 1, wherein a shape of the channel is asymmetrical in cross-section.

6. The archery light mount assembly of claim 1, wherein the carriage is C-shaped in cross section.

7. The archery light mount assembly of claim 1, wherein the locking mechanism comprises a set screw within an opening passing through a side of the carriage.

8. The archery light mount assembly of claim 1, wherein the attachment member comprises double-sided tape.

9. The archery light mount assembly of claim 7, wherein the set screw comprises a nylon tip.

10. An archery sight bar slidable carriage comprising:
a flat upper surface and a channel passing through a body of the carriage parallel to the upper surface, the channel configured for slidable insertion of an archery sight bar;
an adjustable locking mechanism passing through the body of the carriage to both engage the sight bar and prevent movement of the carriage relative to the sight bar and to disengage the sight bar to allow movement of the carriage relative to the sight bar; and
an attachment member positioned on the upper surface and configured to secure an archery light or power source to the carriage.

11. The archery sight bar carriage of claim 10, wherein the channel comprises a dovetail cross-section.

12. The archery sight bar carriage of claim 10, wherein the channel comprises at least five flat surfaces.

13. The archery sight bar carriage of claim 10, wherein a shape of the channel in cross-section is substantially identical to the geometric shape of the sight bar in cross-section.

14. The archery sight bar carriage of claim 10, wherein a shape of the channel is asymmetrical in cross-section.

15. The archery sight bar carriage of claim 10, wherein the carriage is C-shaped in cross section.

16. The archery sight bar carriage of claim 10, wherein the locking mechanism comprises a set screw within an opening passing through a side of the carriage.

17. The archery sight bar carriage of claim 10, wherein the attachment member comprises double-sided tape.

18. The archery sight bar carriage of claim 16, wherein the set screw comprises a nylon tip.
